(19) United States
(12) Patent Application Publication
(10) Pub. No.: US 2005/0231362 A1
(43) Pub. Date: Oct. 20, 2005

(54) Apparatus carrying a mounted RFID circuit for the purpose of deploying and generating a tracking signal (post shot only) from an arrow

(76) Inventors: Charles Franklin Pridmore JR., Winfield, AL (US); Peter Babendreier, Laurel, MD (US)

Correspondence Address: RelativeImpact Inc., P.O. Box 259, Chester, MD, 21619, US

(21) Appl. No.: 11/086,540

(22) Filed: Mar. 23, 2005

Related U.S. Application Data
(60) Provisional application No. 60/563,000, filed on Apr. 19, 2004.
(60) Provisional application No. 60/612,147, filed on Sep. 23, 2004.

(51) Int. Cl. G08B 1/08

(52) U.S. Cl. 340/539.32; 340/572.8; 340/573.2

(57) ABSTRACT

This invention utilizes RFID Technology, plastic injection molded components, a flexible PCB, Micro batteries, active and passive electronic components and antenna wire to form an apparatus (Arrow mounted RFID Carrier) for the purpose of deploying and generating a tracking signal from an arrow mounted RFID Circuit. This device is mounted to the arrow shaft (no special tooling required) and is deployed upon impact with the target. During impact the Carrier assembly opens and separates from the arrow shaft and the antenna wire deploys to a given length, one end of the antenna wire penetrating the target and exiting the opposite side of the target while the trailing end remains exterior to the entry side of the broad head impact surface. Mean while, PCB Mounted components, IE Batteries, saline sensor, RFID Chip, etc, are activated by internal contact with body tissues and begin to emit a low level signal through the antenna wire which is then received by a hand held reader device. Distances of signal sensitivity are impacted by environmental conditions and life cycle of pulses can be limited, preferably to less than 24 hours by adjusting the power draw on the batteries.

### CROSS REFERENCE TO RELATED APPLICATIONS

This is a continuation in part of Ser. No. 60/563,000, filed on Apr. 19, 2004 and Ser. No. 60/612,147 filed on Sep. 23, 2004

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of RFID Technology and more specifically to an apparatus (Arrow mounted RFID Carrier) for the purpose of deploying and generating a tracking signal from an arrow mounted RFID Circuit.

Since May 2003 Charles F. Pridmore Jr. and Peter G. Babendreier (Inventors) have been developing the listed apparatus for use by bow hunting sportsmen. This device takes elements of RFID Technology and incorporates it into a deployable carrier which will help to eliminate wasted game by assisting both experienced and novice sportsmen in tracking targeted and struck game animals. During over 60 years of personal hunting experience by the inventors, they have been exposed to the disappointment in lost trophy's due to ineffective marksmanship, impossible terrain and weather conditions or a combination of multiples of these listed issues.

We are not aware of any similar devices using RFID Technology.

Earlier Technologies were prohibitive based upon size issue with the RFID Chip technology. With reduced component sizes, Battery and RFID Chip and the development of antenna technology, it now becomes possible to deploy this type of device on the modern hunting arrow without any loss of performance, accuracy and functionality.

### BRIEF SUMMARY OF THE INVENTION

The primary object of the invention (Arrow Mounted RFID Carrier) which consist of an assembly of molded plastic components, PCB and antenna wire that mounts on the arrow shaft and houses RFID Electronics that will emit a signal that can be utilized to locate harvested game in a post shot situation.

Another object of the invention is This device is utilized POST SHOT ONLY, that is, it functions only after deployment, impact and insertion within the target animal.

A further object of the invention is that this apparatus will fit and function with most broad head configurations including three of four blade and mechanical verses fixed blade designs.

Another object of the invention is that this apparatus will universally fit all arrow shaft diameters up to 0.400 inches.

A further object of the invention is this apparatus is self contained within one assembly that requires no special tooling for installation.

Other objects and advantages of the present invention will become apparent from the following descriptions, taken in connection with the accompanying drawings, wherein, by way of illustration and example, an embodiment of the present invention is disclosed.

Another object of the invention is In accordance with a preferred embodiment of the invention, there is disclosed an apparatus (Arrow mounted RFID Carrier) for the purpose of generating a tracking signal from a deployed hunting broad head arrow, comprised of a plastic carrier that is universal to the modern hunting broad head configurations currently on the market. Self contained RFID Electronics which consist of RFID Chip, battery, antenna. This apparatus does not negatively impact arrow/broad head performance, and this apparatus deploys RFID Technology in the field that will assist in the successful recovery of harvested game animals.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention, broad head and portion of the arrow shaft.

FIG. 2 is a front end view of the invention, broad head and portion of the arrow shaft.

FIG. 3 is a rear view of the invention, broad head and portion of the arrow shaft.

FIG. 4 is a perspective view of the carrier.

FIG. 5 is a perspective view of the invention in assembly form with out the broad head or arrow shown.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

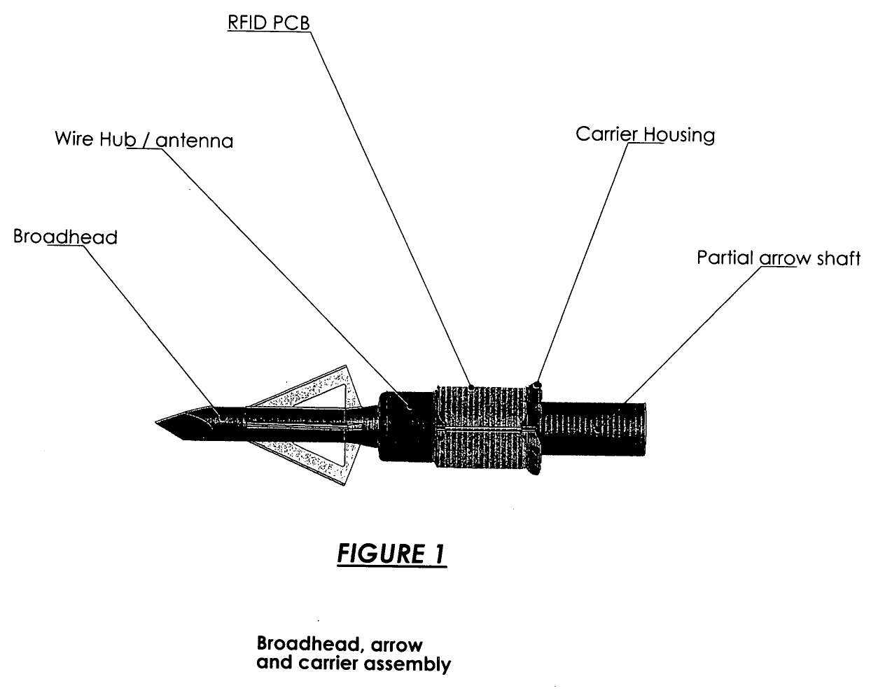

Turning first to FIG. 1 here is shown the invention assembly known here in as the Arrow Mounted RFID Carrier. This assembly is the housing of the carrier for the RFID Electronics and the supporting components. This is also the deployment platform for the RFID Electronics. The assembly components are to be constructed of a molded material or of light gauge wire (38 AWG or thinner) and pcbd substrate, be light weight, aerodynamic and will not impede the performance of the broad head or arrow. The front tip of the carrier is tapered to improve the aerodynamics of the device and arrow assembly.

The carrier is shaped so it can house the RFID circuitry, Battery and Antenna and will separate from the arrow assembly as the arrow impacts and penetrates the target. This will leave the carrier embedded in the target and the RFID component will transmit signals to a reader carried by the archer, this will enable the archer to track the target animal and recover the harvest.

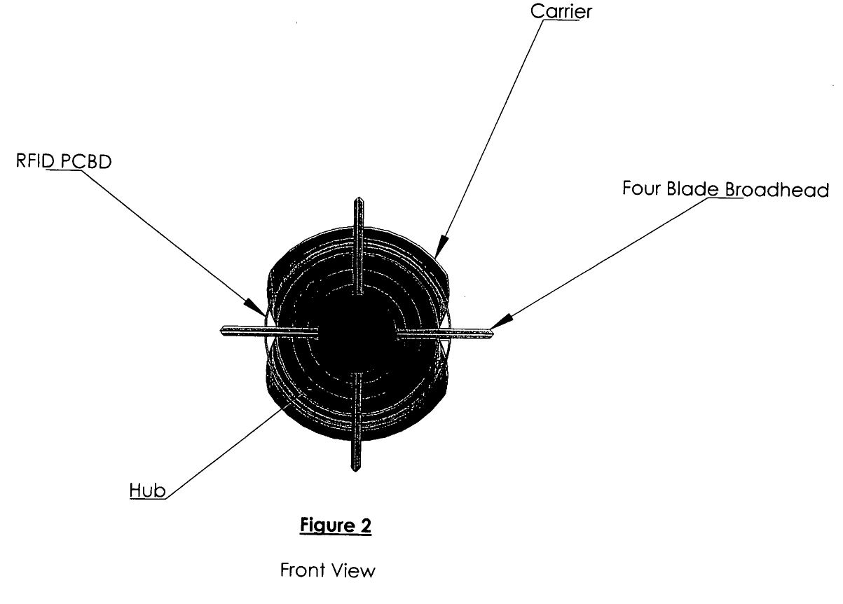

Next in review of FIG. 2 is a front view of the invention mounted to a four blade fixed broad head arrow not shown for clarity.

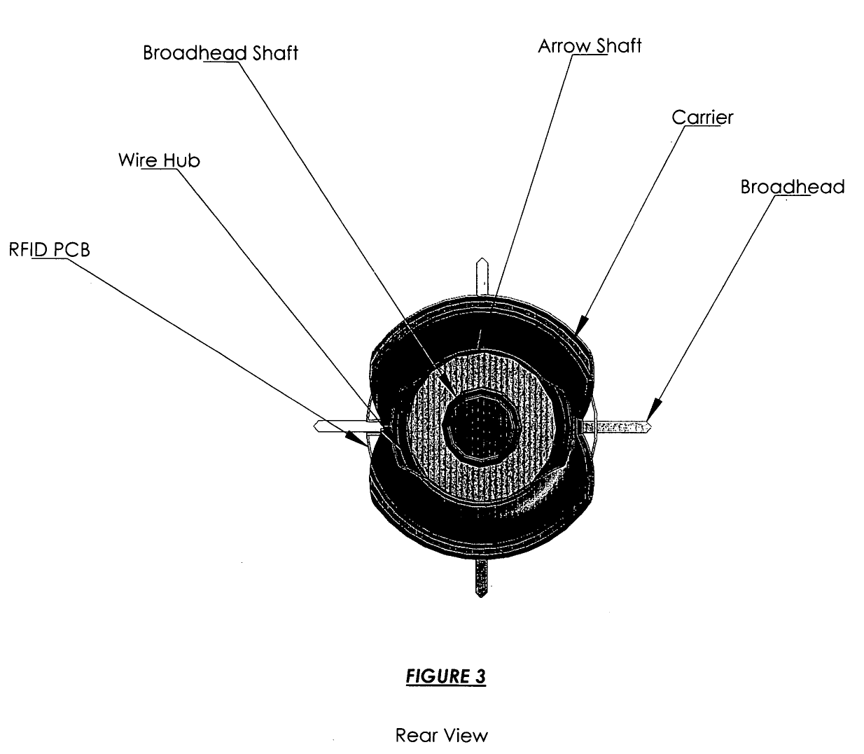

Next in review of FIG. 3 is a rear view of the invention mounted to a four blade fixed broad head arrow shaft diameter shown for clarity.

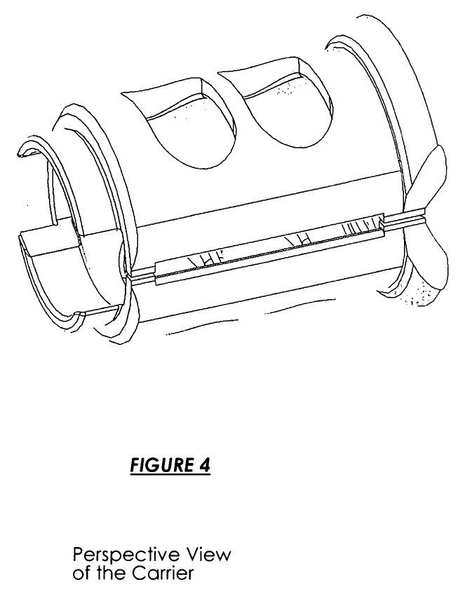

Next in review of FIG. 4 is a perspective view of the carrier. This component is the platform to which the RFID PCBD is mounted. This is the element that separates from the arrow/broad head assembly and deploys the RFID Circuit into the target.

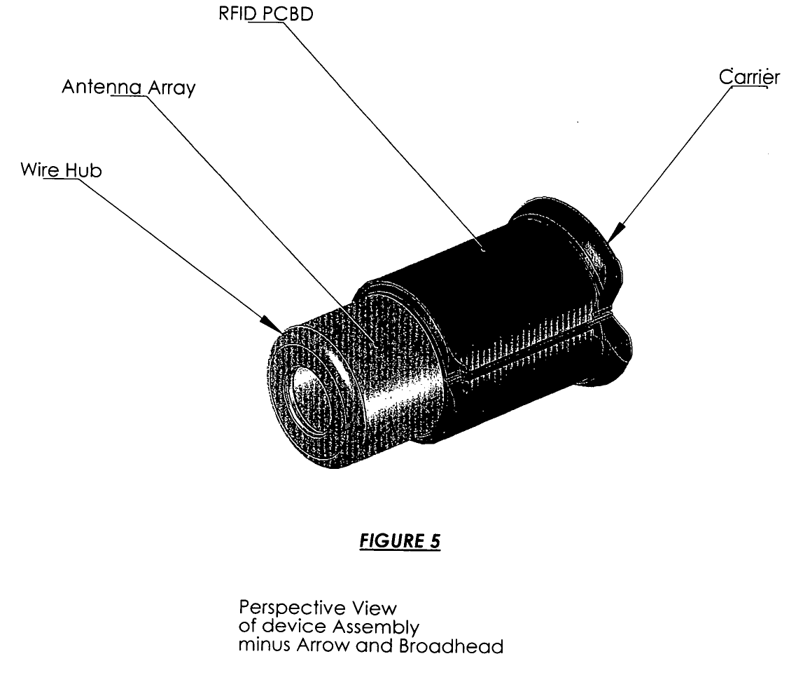

Next in review of FIG. 5 is a perspective view of the invention in assembly form without the arrow or broad head shown.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus (Arrow mounted RFID Carrier) for the purpose of deploying and generating a tracking signal from a deployed hunting broad head and arrow.
comprising:
Plastic carrier assembly which is universal to the modern hunting broad head configurations currently on the market;
Self contained RFID Electronics which consist of RFID Chip, battery,
This apparatus does not negatively impact arrow/broad head performance and this apparatus deploys RFID Technology in the field that will assist in the successful recovery of harvested game animals.
